(19) United States
(12) Patent Application Publication
(10) Pub. No.: US 2017/0083938 A1
(43) Pub. Date: Mar. 23, 2017

(54) Interactive Data-Driven Graphical User Interfaces for Managing Online Advertising

(71) Applicant: Rise Interactive Media & Analytics, LLC, Chicago, IL (US)

(72) Inventors: Brent Laufenberg, Chicago, IL (US); Jon Morris, Chicago, IL (US); Lawrence Fisher, Chicago, IL (US); Bhargav Kunnamkode, Chicago, IL (US); Michael Thone, Chicago, IL (US); Reid Valfer, Chicago, IL (US)

(21) Appl. No.: 14/856,870

(22) Filed: Sep. 17, 2015

(51) Int. Cl. G06Q 30/02

(52) U.S. Cl. CPC G06Q 30/0249; G06Q 30/0246

(57) ABSTRACT

An embodiment may include repeatedly receiving, from one or more online advertising service devices at which a plurality of advertising campaigns are operated, updates to an advertising spending amount for one or more particular advertising campaigns. The embodiment may also include repeatedly receiving, from one or more traffic tracking service devices, updates to an advertising conversion amount for the one or more particular advertising campaigns. The embodiment may further include providing, for display on a graphical user interface, a line item for the one or more particular advertising campaigns including: a first representation of the advertising spending amount compared to an advertising spending goal, and a second representation of the advertising conversion amount compared to an advertising conversion goal. The first representation may be highlighted when the advertising spending amount deviates by more than a threshold extent from the advertising spending goal. The second representation may indicate whether the advertising conversion amount meets the advertising conversion goal.

### BACKGROUND

Online advertising uses the Internet or other data networks to provide promotional and marketing messages to consumers and/or potential customers. It includes email advertising, search engine advertising, social media advertising, various types of web display advertising, and mobile advertising. The parties involved include an advertiser, who provides advertisement (ad) copy, a publisher, who integrates the ads into its online content, and a user, who is presented with the online ads. An online advertising service may match advertisers with publishers, and may select the specific ads that are viewed by particular users that access the publisher's content. Another potential participant is an advertising agency, who may help generate and place the ad copy.

Unlike traditional print, radio, and television advertising, online advertising allows hyper-focused targeting of ads to particular users and groups of users. But, regardless of targeting, it currently lacks the tools for advertisers and advertising agencies to be able to manage advertising budgets on a granular scale or to determine, in near-real-time, the efficacy of the advertisements placed.

### SUMMARY

A first example embodiment may involve repeatedly receiving, by a computing device from one or more online advertising service devices at which a plurality of advertising campaigns are operated, updates to an advertising spending amount for one or more particular advertising campaigns. The first example embodiment may also involve repeatedly receiving, by the computing device from one or more traffic tracking service devices, updates to an advertising conversion amount for the one or more particular advertising campaigns. The first example embodiment may further involve providing, by the computing device for display on a graphical user interface, respective line items for the plurality of advertising campaigns. A line item for the one or more particular advertising campaigns may include (i) a first representation of the advertising spending amount compared to an advertising spending goal for the one or more particular advertising campaigns, and (ii) a second representation of the advertising conversion amount compared to an advertising conversion goal for the one or more particular advertising campaigns. The first representation may be highlighted when the advertising spending amount deviates by more than a threshold extent from the advertising spending goal. The second representation may indicate whether the advertising conversion amount meets the advertising conversion goal.

In a second example embodiment, an article of manufacture may include a non-transitory computer-readable medium, having stored thereon program instructions that, upon execution by a computing device, cause the computing device to perform operations in accordance with the first example embodiment.

In a third example embodiment, a computing device may include at least one processor, as well as data storage and program instructions. The program instructions may be stored in the data storage, and upon execution by the at least one processor, cause the computing device to perform operations in accordance with the first example embodiment.

In a fourth example embodiment, a system may include various means for carrying out each of the operations of the first example embodiment.

These as well as other embodiments, aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 is a high-level depiction of a client-server computing system, according to an example embodiment.

FIG. 2 illustrates a schematic drawing of a computing device, according to an example embodiment.

FIG. 3 illustrates a schematic drawing of a networked server cluster, according to an example embodiment.

FIG. 4 depicts an online advertising diagram, according to an example embodiment.

FIG. 5A depicts an advertising agency offering graphical user interfaces that provide advertising goal and conversion goal tracking, according to an example embodiment.

FIG. 5B depicts a day-by-day advertising budget, according to an example embodiment.

FIG. 5C depicts day-by-day conversion goals, according to an example embodiment.

FIG. 6 depicts an architecture for online advertising budget and goal tracking, according to an example embodiment.

FIG. 7A depicts a pacing overview graphical user interface, according to an example embodiment.

FIG. 7B depicts a spend pacing graphical user interface, according to an example embodiment.

FIG. 7C depicts a goal pacing graphical user interface, according to an example embodiment.

FIG. 7D depicts a spend pacing graphical user interface focusing on advertising campaigns that are over their spending budgets, according to an example embodiment.

FIG. 7E depicts a spend pacing graphical user interface focusing on advertising campaigns that are under their spending budgets, according to an example embodiment.

FIG. 7F depicts a goal pacing graphical user interface focusing on advertising campaigns that are over their conversion goals, according to an example embodiment.

FIG. 7G depicts a goal pacing graphical user interface focusing on advertising campaigns that are under their conversion goals, according to an example embodiment.

FIG. 8 depicts a flow chart, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### 1. Overview

As noted above, online advertising services may facilitate the offering of specific ads from advertisers to particular users. In some embodiments, an online advertising service may partner with publishers (e.g., web sites, search engines, social networks, mobile applications, etc.) that deliver content to users. The advertiser may submit ads for the online advertising service to place, and the online advertising service may select specific ads to display for each affiliated publisher. The ads may be selected dynamically so that they are to likely be related to the content being viewed, or of interest to users that typically view the content. Alternatively or additionally, when demographic or personal information about a particular user is known, the ads may be targeted to that particular user.

Payment models for online advertising vary. In some models, known as cost-per-mille (CPM), advertisers pay a specific amount for every 1000 ads viewed by users (these views are sometimes called “impressions”). On the other hand, in pay-per-click (PPC) models, the advertiser pays when users click on or select a displayed ad, indicating further interest in the product or service being advertised. Newer models include pay-per-performance (PPP) or pay-per-engagement (PPE) advertising, in which the advertiser pays when the user undertakes a particular set of one or more actions. These actions may result in leads for the advertiser, such as users filling out an online form, accessing a particular uniform resource locator (URL), downloading a particular file, watching a particular video, or dialing a particular phone number. These actions may also include conducting an online purchase of a particular product or service.

Regardless of the payment model, the advertiser's payment may be divided, in some fashion, between the content provider serving the ads and the online advertising service. For instance, the content provider may obtain 70% of each unit of payment, while the online advertising service obtains the remaining 30%.

Some online advertising services operate under an auction model. Advertisers may select, for instance, keywords or keyphrases with which they would like their ads associated, as well as a bid amount. The online advertising service then, in turn, displays the ad of the highest bidder on web pages or other media that also display (or are otherwise associated with) the highest bidder's selected keywords or keyphrases. For example, ads bundled with the keywords “auto,” “automobile,” and “car” may be displayed on web sites or other media that contain content related to cars and/or driving. In some cases, the online advertising service may display the ad to a user associated with the selected keywords or keyphrases. The user may have, in the past, expressed interest in these keywords or keyphrases, or is deemed likely to have such an interest. Thus, in the case of the above example, if the user is deemed interested in cars, the ads may be displayed to a user in web sites or other media that are not related to cars and/or driving.

The terms “keywords” and “keyphrases” may refer to single words and groups of words, respectively. For sake of convenience, these terms may be used interchangeably herein.

Measuring the effectiveness of online advertising campaigns can be challenging given the variety of online advertising services and payment models. An advertiser may wish to distribute its advertising budget across more than one online advertising service, and/or may wish to use multiple payment models. The effectiveness may be measured in terms of conversions—the number of users who engaged with the ads of the campaign. But several types of conversions exist: impressions, click-throughs, leads, and purchases. Some of these conversion types may involve assisted conversions. Additional categories of conversions may exist.

Assisted conversions include interactions that a user has with publishers leading up to a conversion. For example, if conversions are measured in terms of purchases, the user may visit a particular publisher several times before conducting the actual purchase. These visits may be information gathering exercises for the user. Nonetheless, the non-purchase visits may be tracked as “assists” and the eventual purchase may be categorized as an assisted conversion.

Online advertising services may be able to track the number of impressions and click-throughs for each ad. However, these services may not have the information to determine that a user who viewed an ad later expressed further interest in, or purchased, a related product. Thus, conversion information regarding the effectiveness of online advertising is currently available only in limited situations.

The embodiments herein support methods, devices, and systems for providing a more complete view of an advertiser's conversions. These embodiments collect and aggregate information from one or more online advertising services, as well as traffic tracking services to enable near-real-time monitoring of advertising spending and advertising conversions. With this information, advertisers and/or their advertising agencies may be able to make faster, more informed decisions about how to allocate their advertising budgets to particular keywords, ad copy, online advertising services, and/or publishers.

Particularly, the embodiments herein describe interactive data-driven graphical user interfaces, in the form of web pages, which display an advertiser's actual spending and actual conversions against representations of associated goals. Advantageously, an advertiser and/or their advertising agency may be able to compare, at a glance, the amount spent on online advertising in a particular defined time period to an advertising budget (or goal) for that time period. The interfaces may highlight whether the actual spending exceeds or falls short of the budget by more than a threshold amount. Similarly, these parties may be able to compare, at a glance, the number of conversions resulting from (or likely resulting from) the one or more particular advertising campaigns over the particular defined time period to a conversion goal for that time period. The interfaces may highlight whether the number of actual conversions meets or falls short of the goal.

In this way, the parties may be able to rapidly determine the effectiveness of each of their advertising campaigns, and whether they should change strategies for any of these campaigns. For instance, the parties may decide to discontinue a campaign with a low conversion rate, and reallocate that budget to a campaign with a higher conversion rate. On the other hand, the parties may decide to increase the advertising budgets for important campaigns with lower than expected conversion rates.

While the embodiments herein are described as providing web-based interfaces, other types of interfaces may be used instead. For instance, any of the web-based interfaces herein may be replaced by interfaces of standalone applications for personal computers, tablets, smartphones, etc. Further, even though online advertising agencies are described throughout this disclosure as placing ads on behalf of advertiser, these agencies are not necessary. Thus, the embodiments herein may be used by advertisers themselves without assistance from an online advertising agency.

Regardless of how they may be implemented, the embodiments herein may make use of one or more computing devices. These computing devices may include, for example, client devices under the control of users, and server devices that directly or indirectly interact with the client devices. Such devices are described in the following section.

### 2. Example Computing Devices and Cloud-Based Computing Environments

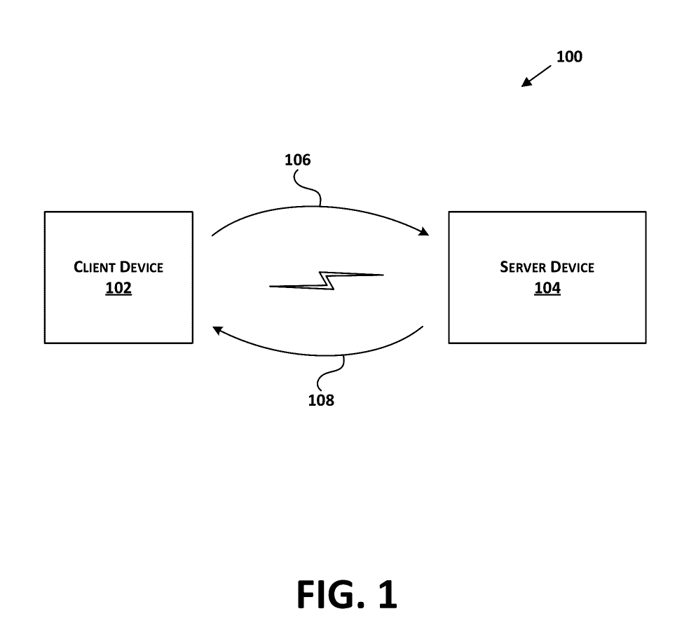

FIG. 1 illustrates an example communication system 100 for carrying out one or more of the embodiments described herein. Communication system 100 may include computing devices. Herein, a “computing device” may refer to either a client device, a server device (e.g., a stand-alone server computer or networked cluster of server equipment), or some other type of computational platform.

Client device 102 may be any type of device including a personal computer, laptop computer, a wearable computing device, a wireless computing device, a head-mountable computing device, a mobile telephone, or tablet computing device, etc., that is configured to transmit data 106 to and/or receive data 108 from a server device 104 in accordance with the embodiments described herein. For example, in FIG. 1, client device 102 may communicate with server device 104 via one or more wireline or wireless interfaces. In some cases, client device 102 and server device 104 may communicate with one another via a local-area network. Alternatively, client device 102 and server device 104 may each reside within a different network, and may communicate via a wide-area network, such as the Internet.

Client device 102 may include a user interface, a communication interface, a main processor, and data storage (e.g., memory). The data storage may contain instructions executable by the main processor for carrying out one or more operations relating to the data sent to, or received from, server device 104. The user interface of client device 102 may include buttons, a touchscreen, a microphone, and/or any other elements for receiving inputs, as well as a speaker, one or more displays, and/or any other elements for communicating outputs.

Server device 104 may be any entity or computing device arranged to carry out the server operations described herein. Further, server device 104 may be configured to send data 108 to and/or receive data 106 from the client device 102.

Data 106 and data 108 may take various forms. For example, data 106 and 108 may represent packets transmitted by client device 102 or server device 104, respectively, as part of one or more communication sessions. Such a communication session may include packets transmitted on a signaling plane (e.g., session setup, management, and teardown messages), and/or packets transmitted on a media plane (e.g., text, graphics, audio, and/or video data).

Regardless of the exact architecture, the operations of client device 102, server device 104, as well as any other operation associated with the architecture of FIG. 1, can be carried out by one or more computing devices. These computing devices may be organized in a standalone fashion, in cloud-based (networked) computing environments, or in other arrangements.

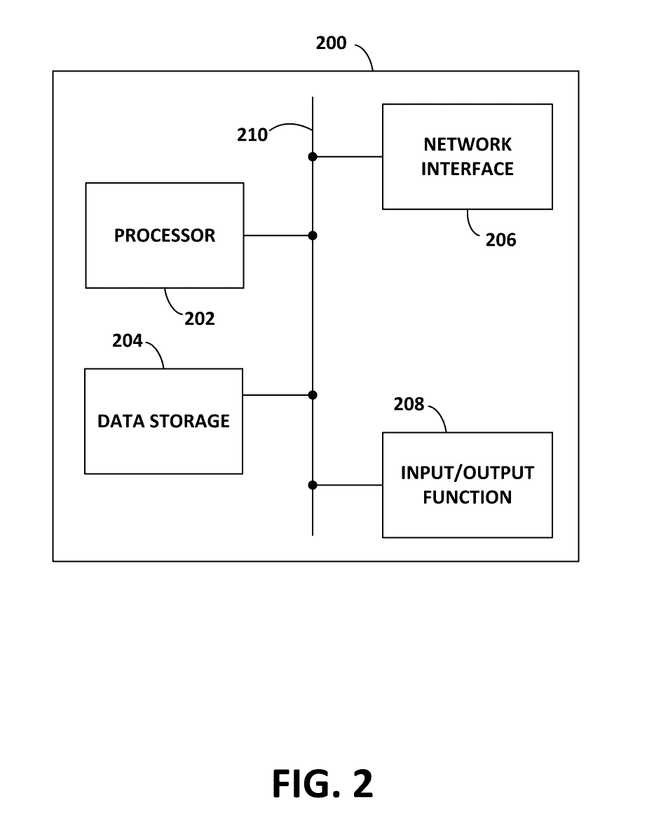

FIG. 2 is a simplified block diagram exemplifying a computing device 200, illustrating some of the functional components that could be included in a computing device arranged to operate in accordance with the embodiments herein. Example computing device 200 could be a client device, a server device, or some other type of computational platform. For purposes of simplicity, this specification may equate computing device 200 to a server from time to time. Nonetheless, the description of computing device 200 could apply to any component used for the purposes described herein.

In this example, computing device 200 includes a processor 202, a data storage 204, a network interface 206, and an input/output function 208, all of which may be coupled by a system bus 210 or a similar mechanism. Processor 202 can include one or more CPUs, such as one or more general purpose processors and/or one or more dedicated processors (e.g., application specific integrated circuits (ASICs), digital signal processors (DSPs), network processors, etc.).

Data storage 204, in turn, may comprise volatile and/or non-volatile data storage and can be integrated in whole or in part with processor 202. Data storage 204 can hold program instructions, executable by processor 202, and data that may be manipulated by these instructions to carry out the various methods, processes, or operations described herein. Alternatively, these methods, processes, or operations can be defined by hardware, firmware, and/or any combination of hardware, firmware and software. By way of example, the data in data storage 204 may contain program instructions, perhaps stored on a non-transitory, computer-readable medium, executable by processor 202 to carry out any of the methods, processes, or operations disclosed in this specification or the accompanying drawings.

Network interface 206 may take the form of a wireline connection, such as an Ethernet, Token Ring, or T-carrier connection. Network interface 206 may also take the form of a wireless connection, such as IEEE 802.11 (Wifi), BLUETOOTH®, or a wide-area wireless connection. However, other forms of physical layer connections and other types of standard or proprietary communication protocols may be used over network interface 206. Furthermore, network interface 206 may comprise multiple physical interfaces.

Input/output function 208 may facilitate user interaction with example computing device 200. Input/output function 208 may comprise multiple types of input devices, such as a keyboard, a mouse, a touch screen, and so on. Similarly, input/output function 208 may comprise multiple types of output devices, such as a screen, monitor, printer, or one or more light emitting diodes (LEDs). Additionally or alternatively, example computing device 200 may support remote access from another device, via network interface 206 or via another interface (not shown), such as a universal serial bus (USB) or high-definition multimedia interface (HDMI) port.

In some embodiments, one or more computing devices may be deployed in a networked architecture. The exact physical location, connectivity, and configuration of the computing devices may be unknown and/or unimportant to client devices. Accordingly, the computing devices may be referred to as “cloud-based” devices that may be housed at various remote locations.

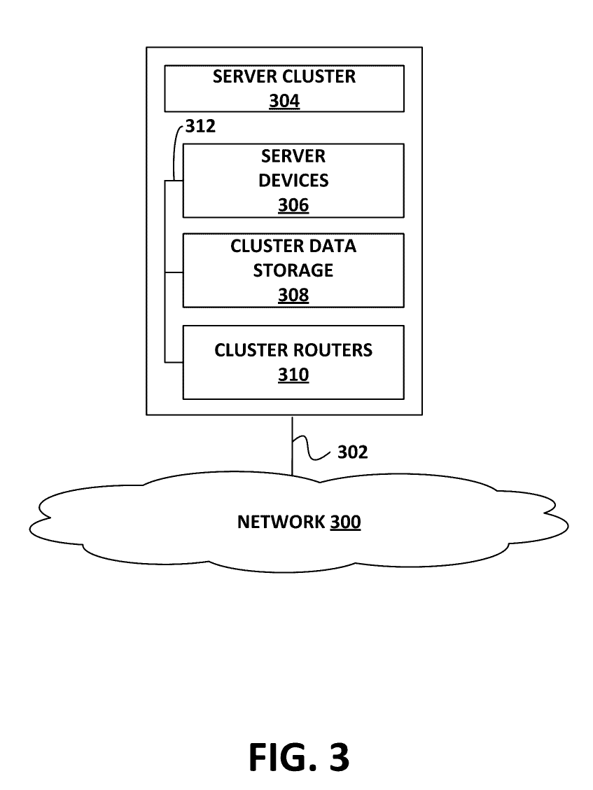

FIG. 3 depicts a cloud-based server cluster 304 in accordance with an example embodiment. In FIG. 3, functions of a server device, such as server device 104 (as exemplified by computing device 200) may be distributed between server devices 306, cluster data storage 308, and cluster routers 310, all of which may be connected by local cluster network 312. The number of server devices, cluster data storages, and cluster routers in server cluster 304 may depend on the computing task(s) and/or applications assigned to server cluster 304.

For example, server devices 306 can be configured to perform various computing tasks of computing device 200. Thus, computing tasks can be distributed among one or more of server devices 306. To the extent that these computing tasks can be performed in parallel, such a distribution of tasks may reduce the total time to complete these tasks and return a result. For purposes of simplicity, both server cluster 304 and individual server devices 306 may be referred to as “a server device.” This nomenclature should be understood to imply that one or more distinct server devices, data storage devices, and cluster routers may be involved in server device operations.

Cluster data storage 308 may be data storage arrays that include disk array controllers configured to manage read and write access to groups of hard disk drives. The disk array controllers, alone or in conjunction with server devices 306, may also be configured to manage backup or redundant copies of the data stored in cluster data storage 308 to protect against disk drive failures or other types of failures that prevent one or more of server devices 306 from accessing units of cluster data storage 308.

Cluster routers 310 may include networking equipment configured to provide internal and external communications for the server clusters. For example, cluster routers 310 may include one or more packet-switching and/or routing devices configured to provide (i) network communications between server devices 306 and cluster data storage 308 via cluster network 312, and/or (ii) network communications between the server cluster 304 and other devices via communication link 302 to network 300.

Additionally, the configuration of cluster routers 310 can be based at least in part on the data communication requirements of server devices 306 and cluster data storage 308, the latency and throughput of the local cluster networks 312, the latency, throughput, and cost of communication link 302, and/or other factors that may contribute to the cost, speed, fault-tolerance, resiliency, efficiency and/or other design goals of the system architecture.

As a possible example, cluster data storage 308 may include any form of database, such as a structured query language (SQL) database. Various types of data structures may store the information in such a database, including but not limited to tables, arrays, lists, trees, and tuples. Furthermore, any databases in cluster data storage 308 may be monolithic or distributed across multiple physical devices.

Server devices 306 may be configured to transmit data to and receive data from cluster data storage 308. This transmission and retrieval may take the form of SQL queries or other types of database queries, and the output of such queries, respectively. Additional text, images, video, and/or audio may be included as well. Furthermore, server devices 306 may organize the received data into web page representations. Such a representation may take the form of a markup language, such as the hypertext markup language (HTML), the extensible markup language (XML), or some other standardized or proprietary format. Moreover, server devices 306 may have the capability of executing various types of computerized scripting languages, such as but not limited to Perl, Python, PHP Hypertext Preprocessor (PHP), Active Server Pages (ASP), JavaScript, and so on. Computer program code written in these languages may facilitate the providing of web pages to client devices, as well as client device interaction with the web pages.

### 3. Example Online Advertising Architectures and Conversion Tracking

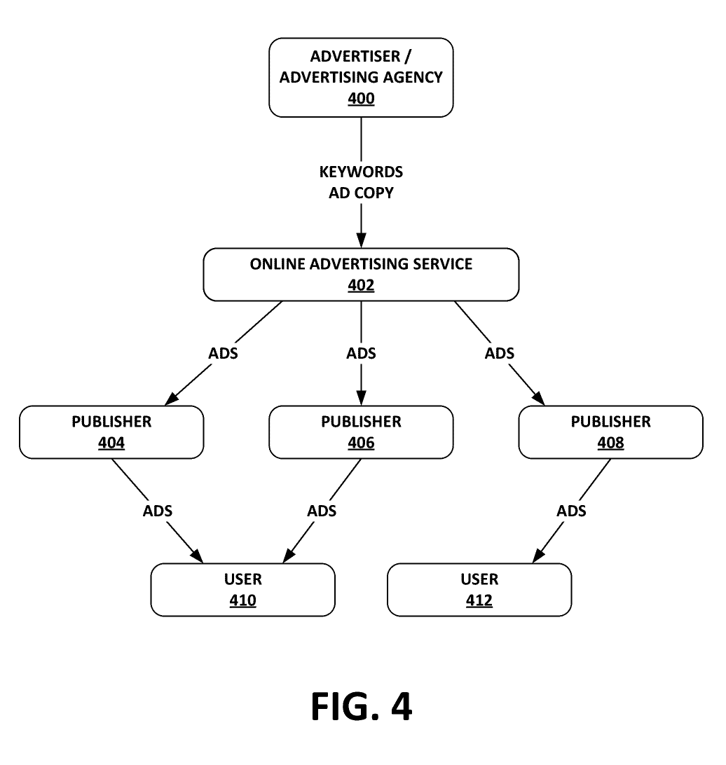

FIG. 4 depicts an online advertising diagram, according to an example embodiment. In FIG. 4, advertiser/advertising agency 400 may provide keywords and/or ad copy to online advertising service 402. The advertiser and the advertising agency may, for example, work together to select the keywords and develop the ad copy. On the other hand, either of these parties may operate independently from the other when selecting the keywords and developing the ad copy. In some embodiments, the advertiser hires the advertising agency to manage the advertiser's online advertising. The advertising agency may also assist the advertiser with other aspects of marketing strategies, branding strategies and/or sales promotions.

Regardless of the exact relationship between the advertiser and the advertising agency, the online advertising may be associated with one or more spending goals and/or conversion goals defined by either party. These goals may take various forms. In some possible examples, the spending goals may include a monthly advertising budget, perhaps with day-by-day spending sub-goals, and the conversion goals may include a target number of monthly conversions, perhaps with day-by-day conversion sub-goals. The conversion goals may also specify how these conversions can be counted. Other possibilities exist.

Online advertising service 402 may be an entity that receives keywords and associated ad copy from one or more advertisers and/or advertising agencies, and provides the ad copy to publishers for display to users. As shown in FIG. 4, online advertising service 402 may provide one or more ads to publishers 404 and 406 that are viewed by user 410, and one or more ads to publisher 408 that are viewed by user 412. Examples of online advertising services include Google's ADWORDS®, Microsoft's BINGO Ads, Automattic's WORDADS®, and so on.

Publishers 404, 406, and 408 may be entities that operate and/or provide web sites, social networks, personal computer applications, mobile applications, search engines, and so on. Each of these types of publishers may provide content potentially of interest to users. Along with this content, publishers 404, 406, and 408 may also provide various types of ads to the users, such as banner ads, column ads, video ads, overlay ads, interstitial ads, etc.

Users 410 and 412 may be individuals accessing the content at publishers 404, 406, and 408. Before, during, and/or after viewing this content, users may view ads. In some cases, users 410 and 412 may be required to view a certain extent of an ad, or view the ad for a certain period of time, before the content is displayed.

Other arrangements with more advertisers, advertising agencies, online advertising services, publishers, and users are possible. In some cases, the number of advertisers, publishers, and/or users may be in the thousands or millions.

As noted above, the ads provided to a particular publisher may be selected to be related to that publisher's content. For instance, if publisher 408 is a web site providing information on automobiles, online advertising service 402 may provide ad copy associated with the keyword “car” to publisher 408. Alternatively or additionally, when the online advertising service has access to information regarding a particular user that is viewing a publisher's content, the online advertising service may provide ads related to known interests of the particular user. Thus, for instance, if user 410 is known to be interested in automobiles, the online advertising service may provide ad copy associated with the keyword “car” to publishers 404 and/or 406 for display to user 410, even if the content that these publishers provide is not related to automobiles.

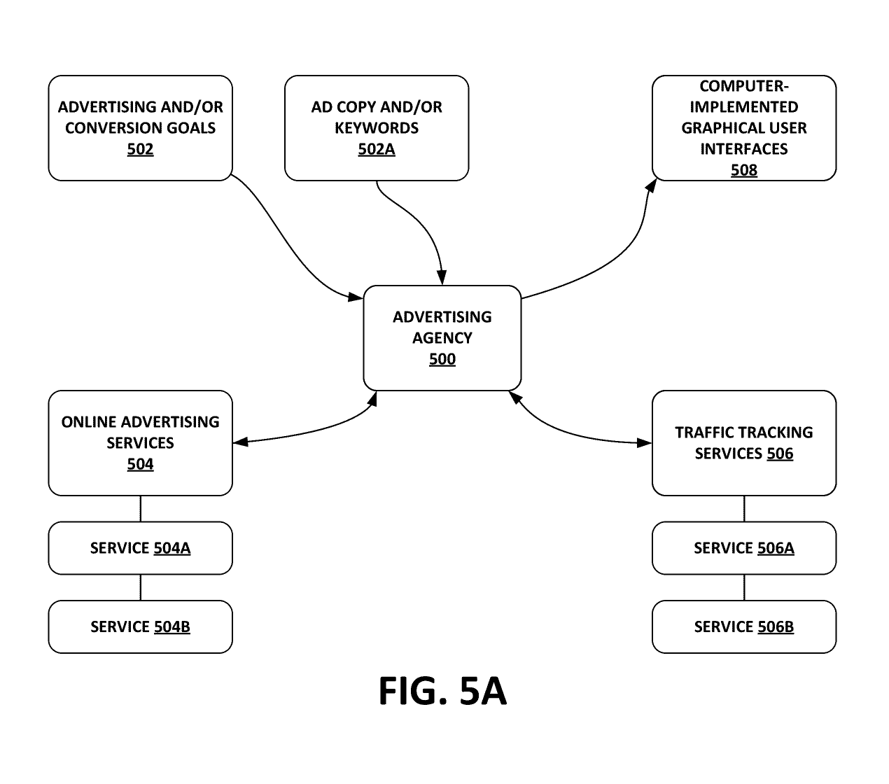

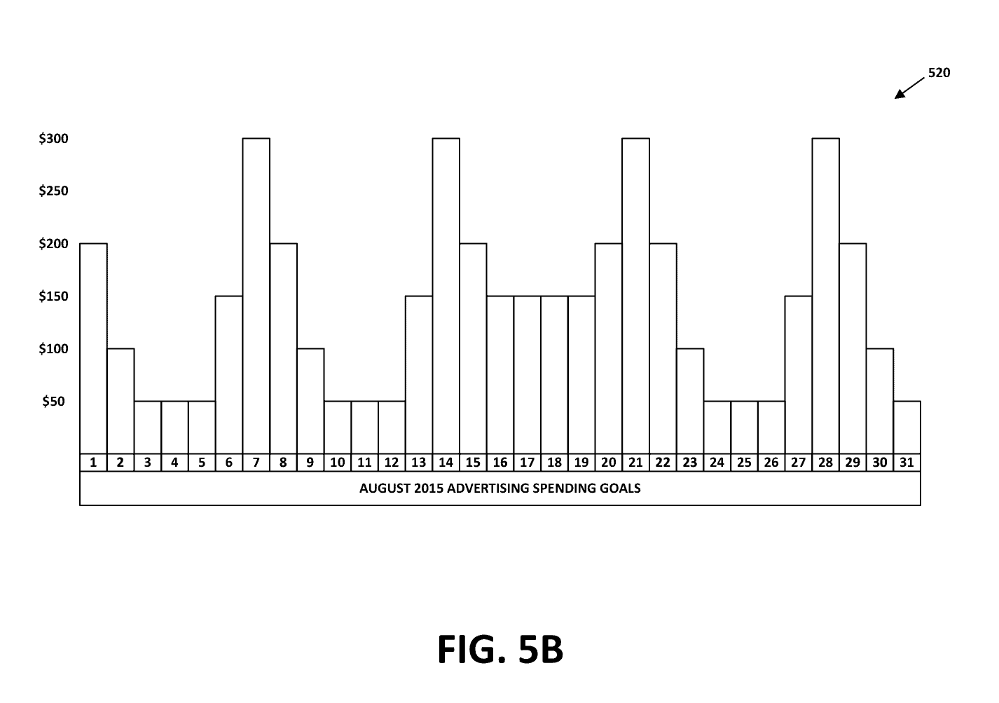

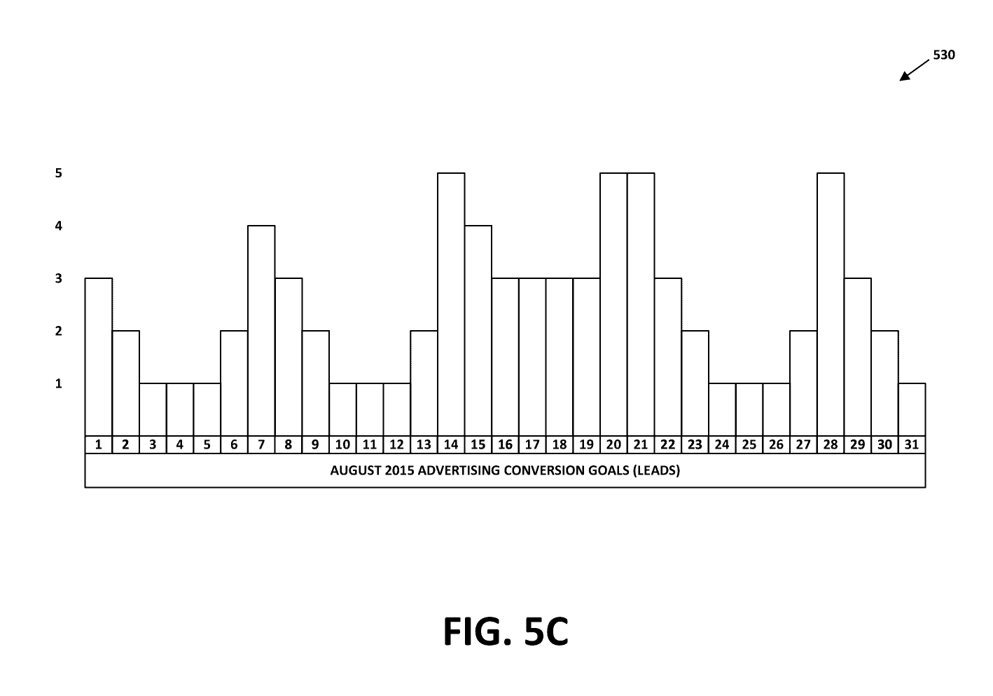

FIG. 5A depicts an advertising agency 500 offering graphical user interfaces that provide online advertising budget and goal tracking, according to an example embodiment. Advertising agency 500 may place ads with one or more online advertising services 504 on behalf of one or more advertisers.

To that end, each advertiser may provide advertising and/or conversion goals 502 to advertising agency 500. Alternatively, advertising and/or conversion goals 502 may be developed by both the advertiser and advertising agency 500, or by advertising agency 500 with little or no input from the advertiser. The advertising goals may be for one or more specific advertising campaigns, and may specify, for instance, day-by-day targeted advertising spending for the advertising campaigns. Similarly, the conversion goals may be for one or more specific advertising campaigns, and may specify, for instance, day-by-day targeted advertising conversions for the advertising campaigns.

As an example, FIG. 5B depicts day-by-day advertising spending goals 520 for the month of August 2015. In FIG. 5B, weekends are indicated with shaded dates, while weekday dates are unshaded. Thus, August 1 is a Saturday, August 2 is a Sunday, August 3 is a Monday, August 4 is a Tuesday, August 5 is a Wednesday, August 6 is a Thursday, August 7 is a Friday, and so on.

Advertising spending goals 520 generally follows a weekly cycle in which target advertising spending increases starting on Thursday of each week, peaks on Fridays, decreases over the weekend, and is at a low point for Monday, Tuesday, and Wednesday. For instance, the advertiser may be a chain store in a shopping mall, where more individuals shop during the weekend than during the week. As a consequence, the advertiser may increase its advertising spending as the weekend approaches, in order to entice more potential customers to visit the store.

The third week of August exhibits a different advertising spending cycle than the rest of the month. This may be due to the advertiser having a week-long sale (e.g., a back-to-school sale) in which it expects more individuals than usual to be visiting the mall. Thus, the advertiser may increase its online advertising accordingly. For instance, the advertisements may be in the form of electronic or printable coupons for items sold at the store.

Similar to FIG. 5B, FIG. 5C depicts day-by-day advertising conversion goals 530 for the month of August 2015. These advertising conversion goals are measured in in terms of leads. In the case of the chain store in the shopping mall, leads might be a potential customer downloading an online ad or registering for a promotion. In other embodiments, advertising conversion goals 530 might be based on expected revenue from advertising.

In some cases, the advertising campaign may measure different types of conversions and assign a respective weight to each. For instance, a purchase might be worth 1 conversion, placing a representation of a good or service in an online shopping cart might be worth 0.8 conversions, downloading a coupon might be worth 0.6 conversions, clicking-through an ad might be worth 0.4 conversions, and an impression might be worth 0.2 conversions. In this way, multiple types of conversions can be measured, for instance, according to their prospective values.

Advertising conversion goals 530 also follows a rough weekly cycle in which target advertising goals increase starting on Thursday of each week, peak on Fridays, decrease over the weekend, and are at a low point for Monday, Tuesday, and Wednesday. Thus, advertising conversion goals 530 reflects that the store expects a number of leads that is commensurate with its advertising spending.

Advertising spending goals 520 and advertising conversion goals 530 may vary in form. In some cases, these items may be specified in a text, spreadsheet, or XML file, for instance. Other possibilities exist. In some cases, advertising spending goals 520 and/or advertising conversion goals 530 may be automatically retrieved by a computing system of advertising agency 500.

Turning back to FIG. 5A, each advertiser may also provide ad copy and/or keywords 502A to advertising agency 500. Ad copy may include text, graphics, audio, and/or video that make up an online ad. Keywords may include one or more words or phrases that the advertiser seeks to associate with the ad copy. In some cases, the ad copy and/or keywords may be developed by the advertiser, both the advertiser and advertising agency 500, or by advertising agency 500 with little or no input from the advertiser.

Given advertising and/or conversion goals 502 and ad copy and/or keywords 502A, advertising agency 500 may place ads with one or more of online advertising services 504. As just one example, service 504A may be Google's ADWORDS®, while service 504B may be Microsoft's BINGO Ads. Thus, advertising agency 500 may provide the ad copy and associated keywords to one or more of online advertising services 504. In some cases, the same ad copy and keywords may be used for each service, and in other cases, ad copy and keywords may differ between at least some of these services. Once the ad copy and keywords are provided, online advertising services 504 may begin providing ads for their respective publishers to display to users.

Each set of ad copy and associated keywords may be part of a distinct advertising campaign. Some advertising campaigns may include multiple sets of ad copy and associated keywords. In some cases, the same ad copy and/or associated keywords can be used across multiple campaigns and/or multiple advertising accounts. For example, an advertiser may have three main brands, each with its own advertising campaign defined by respective sets of ad copy and associated keywords. However, the advertiser may also advertise its company name, with different ad copy and associated keywords, across all of these brands.

As one or more advertising campaigns are launched and supported in this fashion, advertising agency 500 may determine conversions from online advertising services 504 themselves, as well as traffic tracking services 506. Online advertising services 504 may be able to report the number of impressions and click-throughs for a particular ad or advertising campaign, but might not be able to report leads or revenue for the campaign. Thus, advertising agency 500 may use traffic tracking services 506 for these purposes.

Traffic tracking services 506 may include various types of analytics services that track and record user traffic. These may include web based analytics, application (or app) based analytics, phone call based analytics, and so on. Examples of traffic tracking services include Google Analytics, Adobe Analytics, and Invoca call tracking.

As an example of web based analytics, a traffic tracking service (e.g., service 506A and/or 506B) may allow an advertiser to insert a unique tracking code into one or more of the web pages on the advertiser's web site. This tracking code may be a snippet of JavaScript or some other programming language. The tracking code may be silently executed by the user's web browser when the user browses the page(s). The tracking code may collect information about the user (e.g., Internet Protocol (IP) address, and/or information about the user's web browser or computing device) and send this information to a traffic tracking service device. Additionally, the tracking code may set one or more browser cookies in the user's web browser. These cookies may store information such as whether the visitor has been to the site before, the timestamp of the current visit, and the referrer site or advertising campaign that directed the visitor to the page (e.g., search engine, ad copy, keywords, etc.).

As an example of phone based analytics, an advertiser's various advertising campaigns, keywords, web pages, and so on may each be associated with a telephone number. More than one telephone number may be used so that specific advertising campaigns, keywords, web pages can be identified.

For instance, an advertiser may be running two different advertising campaigns, each with a different telephone number (e.g., a “vanity” number used only for this purpose). In the ad copy for these campaigns, the respective phone numbers may appear. For instance, the ad copy may suggest that a user call the respective phone number if they are interested in the product or service being advertised. Each phone number may be a specially assigned number that is only used for receiving calls related to the respective ad. Thus, each incoming phone call to a particular tracked phone number can be counted as a conversion. As an example, a traffic tracking service may provide software on a computer than receives the incoming call, identifies the associated campaign, and records this information, perhaps with the caller's phone number. Then, the software may route the call to an agent who answers the call.

Advertising agency 500 may continuously or repeatedly retrieve, from online advertising services 504 and traffic tracking services 506, information regarding the amount spent on advertising as well as the conversions for each advertising campaign. This information may be presented in various ways on computer-implemented graphical user interfaces 508, some of which are described below. Since the amount spent and the conversions per advertising campaign can change minute to minute (or even more frequently), advertising agency may continuously, periodically, or from time to time, retrieve updated representations of these values. In some cases, the retrieval may take place every 1, 2, 5, 10, 15, 20, 30 or 60 minutes, once per every one or more hours, or randomly. With this updated information, computer-implemented graphical user interfaces 508 may be revised accordingly to reflect the information.

Continuous retrieval of this information may involve a computing device affiliated with advertising agency 500 retrieving the information from online advertising services 504 and traffic tracking services 506 at a particular time. When that retrieval completes, the computing device may initiate another such retrieval. Alternatively, the computing device may wait a period of time (e.g., a few seconds or minutes) before initiating a subsequent retrieval.

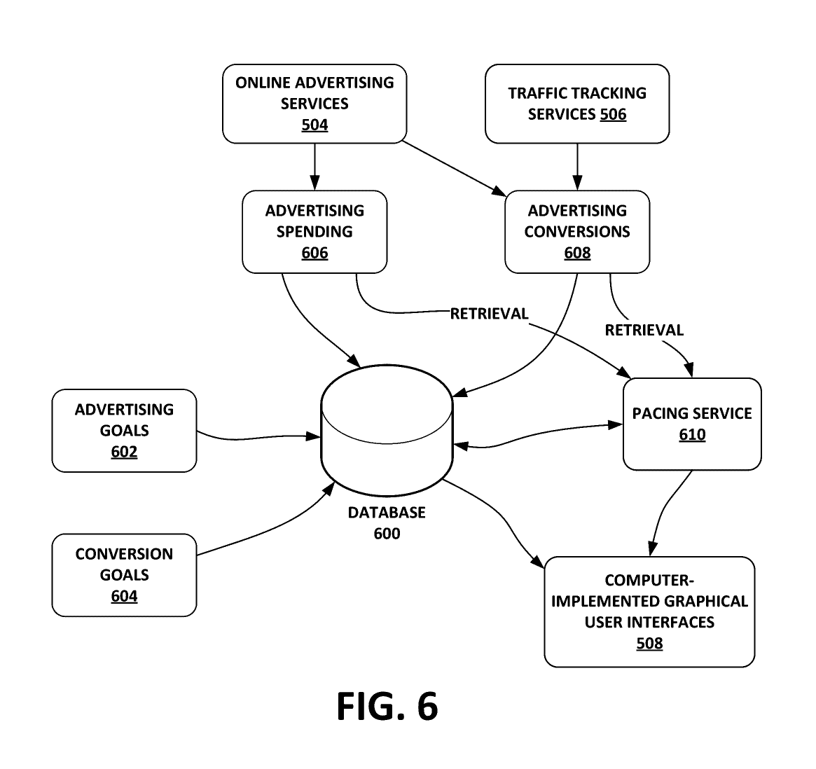

FIG. 6 depicts an architecture for online advertising spending goal and conversion goal tracking, according to an example embodiment. FIG. 6 provides another view of the embodiments discussed in the context of FIGS. 4, 5A, 5B, and 5C.

In FIG. 6, online advertising services 504 and traffic tracking services 506 provide advertising spending 606 and advertising conversions 608, each of which may be accessible via respective computing devices. Pacing service 610 may be software that operates on another computing device, and may retrieve advertising spending 606 and advertising conversions 608. Pacing service 610 may transmit representations of advertising spending 606 and advertising conversions 608 to database 600. Database 600 may store these representations, as well as previously-received representations of advertising spending 606 and advertising conversions 608. Further, advertising goals 602 and conversion goals 604 also may be incorporated into database 600. Based on one or more of advertising goals 602, conversion goals 604, advertising spending 606, and advertising conversions 608, database 600 and/or pacing service 610 may generate computer-implemented graphical user interfaces 508.

### 4. Example Graphical User Interfaces

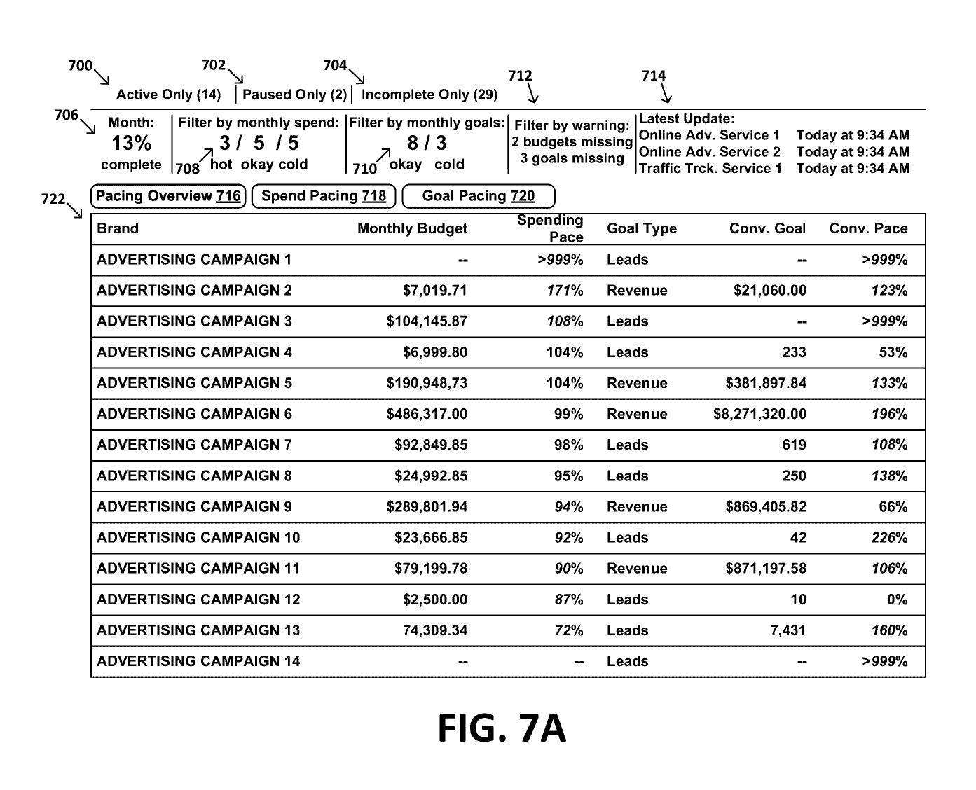

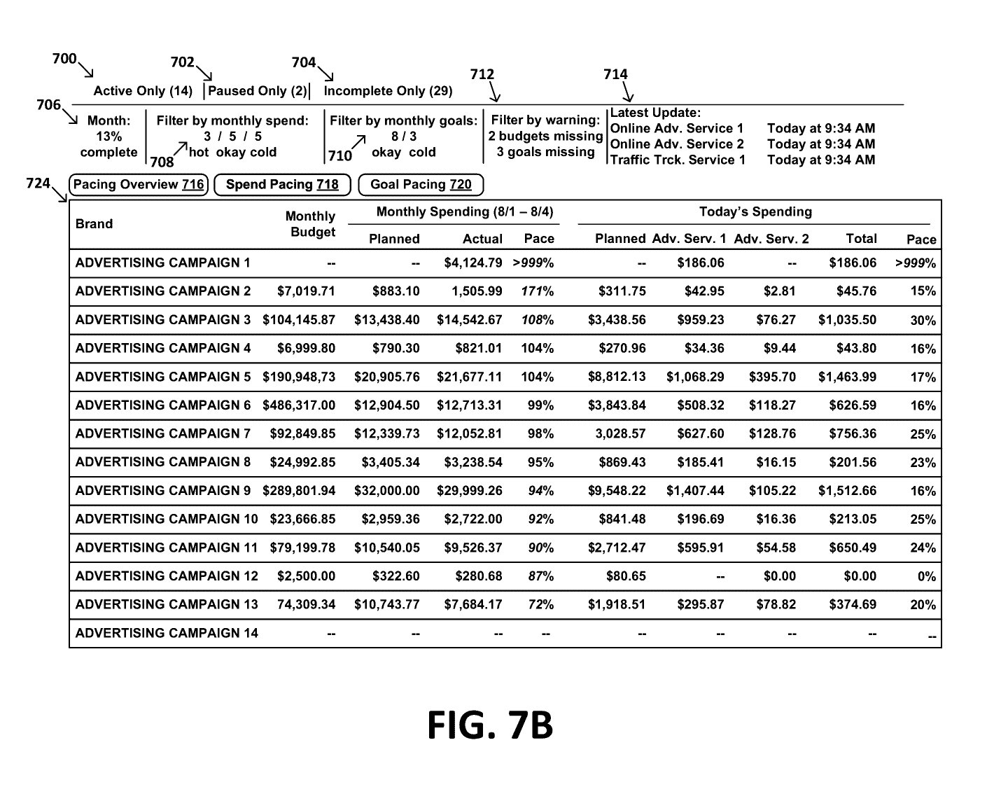

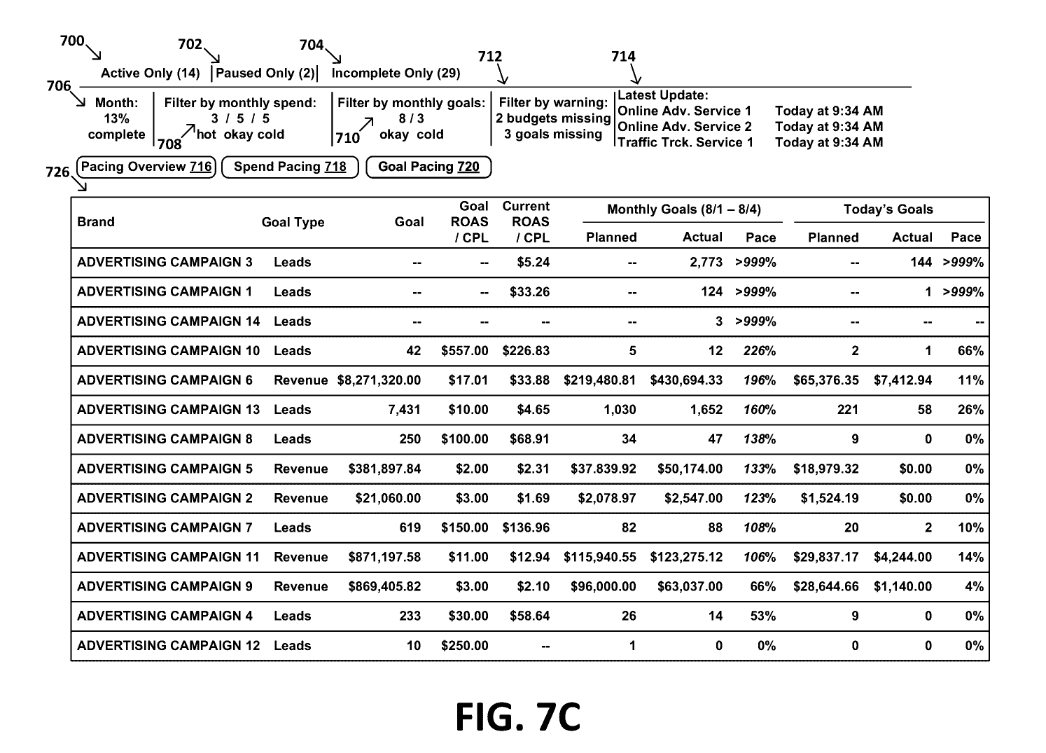

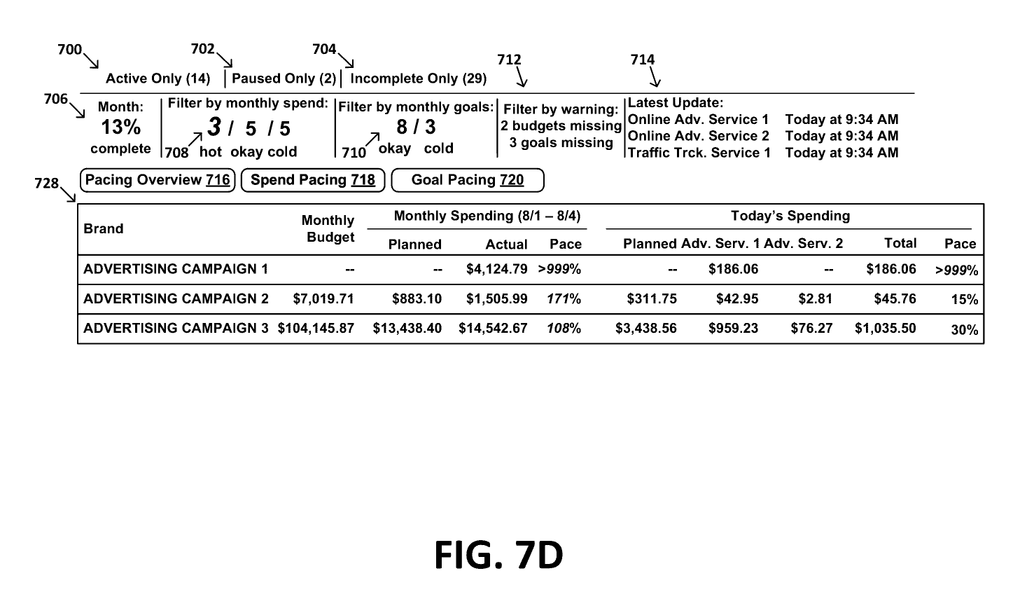

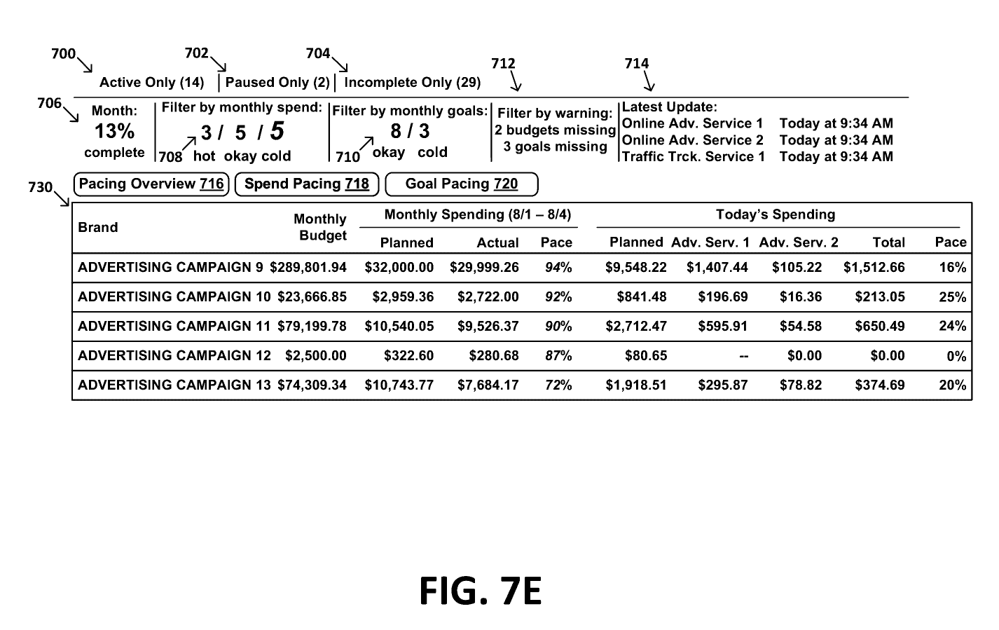

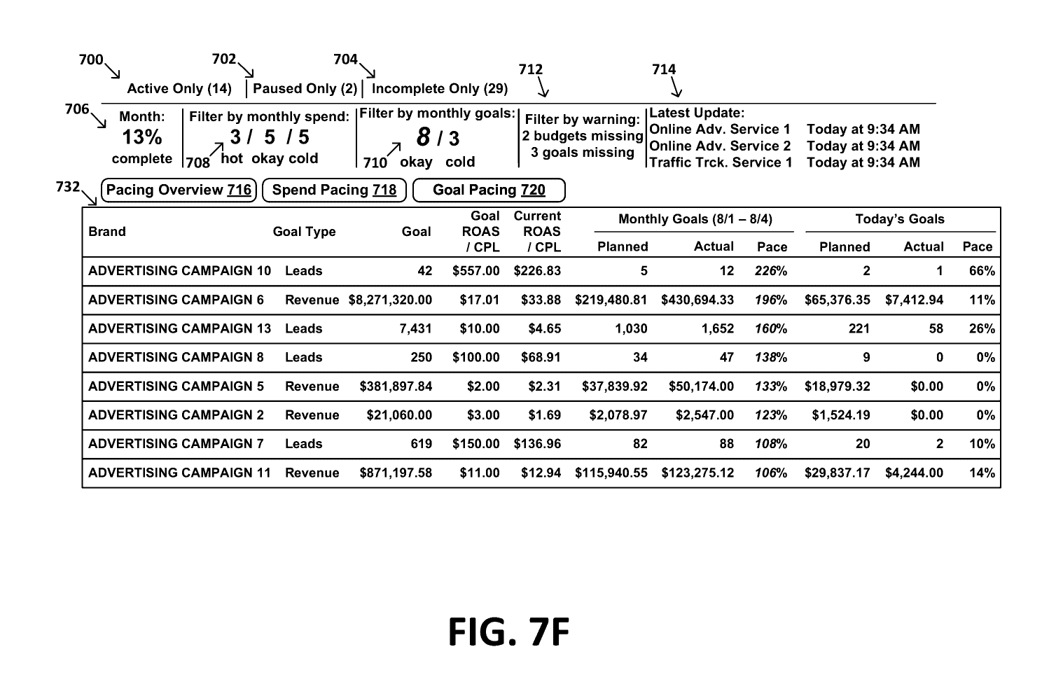

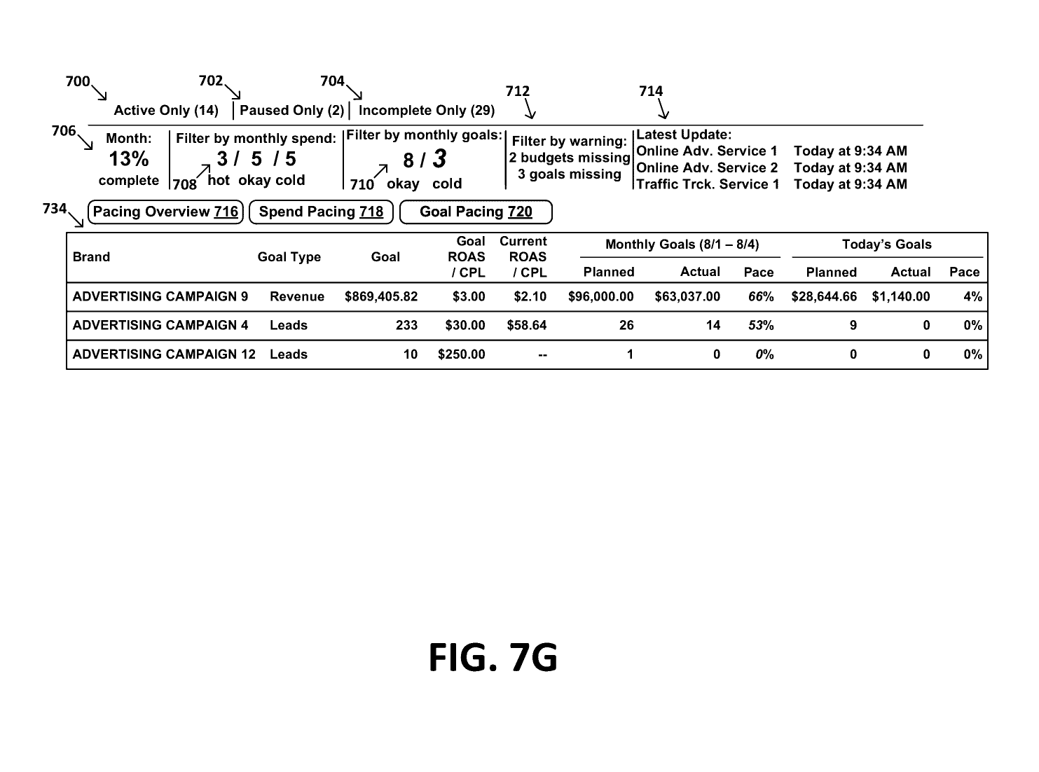

FIGS. 7A-7G depict graphical user interfaces, in accordance with example embodiments. Each of these graphical user interfaces may be provided for display on a client device. The information provided therein may be derived, at least in part, from data stored in a database, such as database 600. Nonetheless, these graphical user interfaces are merely for purposes of illustration. The applications described herein may provide graphical user interfaces that format information differently, include more or less information, include different types of information, and relate to one another in different ways.

FIGS. 7A-7G depict graphical user interfaces that display various types of pacing information. This pacing information may provide an up-to-date visual comparison of how closely advertising spending for one or more particular advertising campaigns is to advertising spending goals for those campaigns. The pacing information may also provide an up-to-date visual comparison of how closely advertising conversions for the one or more particular advertising campaigns are to advertising conversions goals for those campaigns. Thus, these graphical user interfaces allow an advertiser and/or advertising agency to rapidly determine the effectiveness of the advertising for their campaigns. For instance, these parties can easily identify when advertising spending is deviating from advertising spending goals and when advertising conversions are deviating from advertising conversion goals.

FIG. 7A depicts an example pacing overview graphical user interface. This interface includes a header that contains active only control 700, paused only control 702, incomplete only control 704, percent completion indicator 706, monthly spend filtering control 708, monthly goal filtering control 710, warning filtering control 712, latest update indicator 714, pacing overview control 716, spend pacing control 718, and goal pacing control 720. This header, or variations thereof, may be common through at least some of the various related graphical user interfaces herein.

The interface also includes line items 722, which lists a number of advertising campaigns with information related to each campaign arranged in columns. One or more of these columns may be sortable. For instance, if the top of the conversion pacing column (the rightmost column) is clicked on, hovered over, or otherwise selected, line items 722 may be sorted in ascending or descending order of conversion pace.

For each listed advertising campaign, the monthly advertising budget thereof may be provided. The monthly advertising budgets may be total monthly advertising budgets (as shown in FIG. 7A), month-to-date advertising budgets or daily advertising budgets. In some cases, the monthly and daily advertising budgets may be based on day-by-day advertising goals, such as that of FIG. 5B.

In FIG. 7A (as well as some of the following figures), the advertising campaigns are listed under the column heading of “brand.” Thus, each advertising campaign may be associated with a particular brand of a company. Alternatively or additionally, each brand can be associated with one or more advertising campaigns, and the overall effectiveness of these campaigns may be presented per-brand. Thus, herein, the term “advertising campaign” or “campaign” may refer to an advertising campaign, one or more advertising campaigns for a particular brand, and/or one or more advertising campaigns for a particular brand subcategory.

Multiple brands from multiple companies may be included in line items 722. But, in some cases, individual brands may be subdivided further. For instance, if there is a particular brand of clothing that includes both men's and women's apparel, two advertising campaigns for the brand, one for the men's apparel and one for the women's apparel may exist. Since the marketing, advertising, and sales characteristics of these types of apparel can differ dramatically, each type may be presented in FIG. 7A as a different campaign even though they are from the same brand.

An advertising spending pace (“spending pace”) is also included in line items 722, as a percentage, for each advertising campaign. This percentage may be the amount spent so far on the advertising campaign divided by the month-to-date budget of the advertising campaign. For instance, FIG. 7A reflects the state of advertising campaigns on the date of August 4. Thus, the data in the spend pacing column of line items 722 may represent, for each advertising campaign, the sum of advertising spending over August 1-4 divided by the sum of the day-by-day advertising goals defined for August 1-4.

A goal type (“goal type”) is also included in line items 722 for each advertising campaign. This specifies whether the conversion goals of the advertising campaigns take the form of impressions, click-throughs, leads, revenue, some combination thereof, or some other type of conversion. Thus, while only conversion goals of leads and revenue are shown in line items 722, other goal types may be possible.

An advertising conversion goal (“conv. goal”) is also included in line items 722 for each advertising campaign. This specifies either a monthly target revenue amount or a monthly target number of leads that the associated advertising is desired (or expected) to produce. The monthly targets may be total monthly advertising conversion goals (as shown in FIG. 7A) or month-to-date advertising conversion goals. In some cases, the monthly and daily advertising conversion goals may be based on day-by-day advertising conversion goals, such as those of FIG. 5C.

An advertising conversion pace (“conv. pace”) is also included in line items 722, as a percentage, for each advertising campaign. This percentage may represent the month-to-date progress of the advertising campaign toward reaching its conversion goal(s). As noted above, FIG. 7A reflects the state of advertising campaigns on the date of August 4. Thus, the data in the advertising conversion pace of line items 722 may represent, for each advertising campaign, the sum of advertising conversion goals (e.g., leads or revenue) over August 1-4 divided by the sum of the day-by-day advertising conversion goals defined for August 1-4.

As shown in line items 722, whenever the advertising spending exceeds or falls short of the advertising spending goal by more than a threshold amount for one or more particular advertising campaigns, the associated advertising spending pace may be highlighted in some fashion. For instance, in FIG. 7A, this threshold amount is 5%. Thus, the advertising spending paces for advertising campaigns 1, 2, and 3 are italicized. Likewise, the advertising spending paces for advertising campaigns 9, 10, 11, 12, and 13 are italicized to indicate that their respective advertising spending falls short of their respective advertising spending goals by more than 5%.

Also shown in line items 722, when the advertising conversions meet the advertising conversion goal for one or more particular advertising campaigns, the associated advertising conversion pace may be highlighted in some fashion. Thus, the advertising conversion paces for advertising campaigns 1, 2, 3, 5, 6, 7, 8, 10, 11, and 13 are italicized.

In some embodiments, the highlighting may take one or more forms other than italicizing. For instance, an advertising spending pace indicating that advertising spending exceeds the associated advertising spending goal by more than the threshold amount may be displayed in one color. An advertising spending pace indicating that advertising spending is within the threshold amount of the associated advertising spending goal may be displayed in another color. An advertising spending pace indicating that advertising spending falls short of the respective advertising spending goal by more than the threshold amount may be presented in yet another color. Similarly, when advertising conversions meet the respective advertising conversion goal, the associated advertising conversion pace may be presented in a different color than an advertising conversion goal pace for a campaign in which advertising conversions do not meet the respective advertising conversion goal.

Among other advantages, these features of the graphical user interface allow the advertiser and/or advertising agency to rapidly determine advertising campaigns for which the advertising spending is currently over budget or under budget. Advertising campaigns can go over budget easily, especially when the advertiser and/or advertising agency find themselves having to bid higher than expected to place their ads with one or more online advertising services. Advertising campaigns can also easily go under budget when the advertiser and/or advertising agency forget to place ads with an online advertising service during a given time frame. Also, when an advertising agency is managing advertising campaigns for a large number of advertisers, the advertising agency may find it beneficial to be able to rapidly determine which advertising campaigns are over or under budget. With the graphical user interface shown in FIGS. 7A-7G, for example, the advertiser and/or advertising agency can respond to such deviations within minutes or hours, rather than within the days or weeks that used to pass before these corrections were applied.

Also, these features of the graphical user interface allow the advertiser and/or advertising agency to rapidly determine which advertising campaigns are meeting their advertising conversion goals, and which are not. This allows the advertiser and/or advertising agency to detect, within hours or days, problems that used to take weeks or months to recognize. Once an advertising campaign with under-performing conversions is identified, efforts can be taken to adjust the amount or the focus of the associated advertising spending.

Turning back to the controls and indicators in the header of FIG. 7A, each of these elements may serve to further illustrate aspects of the graphical user interface, modify the graphical user interface, or display a new graphical user interface.

Active only control 700, paused only control 702, and incomplete only control 704 may filter the advertising campaigns that appear in line items 722. As shown in FIG. 7A, for each of these controls, the number of advertising campaigns, number of brands, and/or number of brand subcategories that meet the criteria of the control may appear in parenthesis.

Active advertising campaigns are ones for which advertising spending is occurring and conversions can be measured. The 14 advertising campaigns in line items 722 may be considered to be active. From other interfaces, active only control 700 may cause the graphical user interface to change so that only active advertising campaigns are displayed.

Paused advertising campaigns, on the other hand, are one for which advertising is not supposed to be occurring. Some products or services are seasonal, and their associated advertising campaigns are paused when these products or services are off-season. For instance, advertising for hot chocolate might be paused during summer months, and advertising for lawn services might be paused during winter months. Paused only control 702 may cause the graphical user interface to change so that only paused advertising campaigns are displayed. This particular display may be used so that the advertiser and/or advertising agency can verify that there is no advertising spending for these campaigns.

Incomplete advertising campaigns are ones for which advertising spending can be monitored, but advertising conversions either cannot be monitored or have not yet been set up to be monitored. Thus, the performance of these advertising campaigns cannot fully be measured. Incomplete only control 704 may cause the graphical user interface to change so that only incomplete advertising campaigns are displayed.

Percent completion indicator 706 may specify the extent of the month that has passed so far. As an example, in FIG. 7A advertising campaign information for August 4 is shown. Thus, percent completion indicator 706 specifies that 13% of the month of August has passed so far. This indicator provides an easy way of assessing the importance of the spending pace or conversion pace of advertising campaigns. For instance, at the beginning of the month, it may be relatively easy to take action so that advertising spending and conversions meet their respective goals. But, toward the end of the month, it may be much more difficult to do so.

Monthly spend filtering control 708 specifies the number of “hot,” “okay,” and “cold” advertising campaigns with respect to their advertising spending paces. In this context, a “hot” advertising campaign may have advertising spending that exceeds the campaign's advertising spending goal by more than a threshold amount. Thus, in line items 722, advertising campaigns 1, 2, and 3 are “hot.” An “okay” advertising campaign may have an advertising spending that is within the threshold amount of the campaign's advertising spending goal. Thus, in line items 722, advertising campaigns 4, 5, 6, 7, and 8 are “okay.” A “cold” advertising campaign may have advertising spending that is below the threshold amount of the campaign's advertising spending goal. Thus, in line items 722, advertising campaigns 9, 10, 11, 12, and 13 are “cold.” Note that advertising campaign 14 has an undefined advertising budget, so this campaign does not fall into any of the three categories.

Monthly spend filtering control 708 may have sub-controls that cause the graphical user interface to change so that only “hot,” “okay,” or “cold” advertising campaigns are displayed. For instance, if a user clicks on, hovers overs, or otherwise indicates the “3” symbol in spend filtering control 708, the graphical user interface may change to display only the “hot” advertising campaigns. Examples of only “hot” advertising campaigns are shown in FIG. 7D, and examples of only “cold” advertising campaigns are shown in FIG. 7E.

Monthly goal filtering control 710 specifies the number of “okay” and “cold” advertising campaigns with respect to their advertising conversion pace. In this context, an “okay” advertising campaign may have advertising conversions that exceed the campaign's advertising conversion goal. Thus, in line items 722, advertising campaigns 2, 5, 6, 7, 8, 10, 11, and 13 are “okay.” A “cold” advertising campaign may have advertising conversions that are below the threshold amount of the campaign's advertising conversion goal. Thus, in line items 722, advertising campaigns 4, 9, and 12 are “cold.” Note that advertising campaigns 1, 3, and 14 have undefined conversion goals, so these campaigns do not fall into either of the two categories. Monthly goal filtering control 710 may have sub-controls that cause the graphical user interface to change so that only “okay” or “cold” advertising campaigns are displayed. For instance, if a user clicks on, hovers overs, or otherwise indicates the “8” symbol in monthly goal filtering control 710, the graphical user interface may change to display only the “okay” advertising campaigns. Examples of only “okay” advertising campaigns are shown in FIG. 7F, and examples of only “cold” advertising campaigns are shown in FIG. 7G.

Warning filtering control 712 specifies the number of advertising campaigns without advertising goals (“budgets”) and conversion goals (“goals”), respectively. In line items 722, advertising campaigns 1 and 14 are missing advertising goals, and advertising campaigns 1, 3, and 14 are missing conversion goals. Thus, warning filtering control 712 indicates that 2 budgets are missing and 3 goals are missing. Warning filtering control 712 may have sub-controls that cause the graphical user interface to change so that only advertising campaigns with missing budgets or missing goals are displayed. For instance, if a user clicks on, hovers overs, or otherwise indicates the “2” symbol in warning filtering control 712, the graphical user interface may change to display only the advertising campaigns with missing budgets.

Latest update indicator 714 specifies the most recent times at which information from online advertising services and traffic tracking services were retrieved. As noted previously, online advertising services may maintain records of advertising spending for various advertising campaigns, and traffic tracking services may maintain records from which conversions for various advertising campaigns can be determined. A pacing tool operating on a computing device may continuously, periodically, or from time to time retrieve and update this information from online advertising services and traffic tracking services. For instance, in FIG. 7A, latest update indicator 714 shows that information was most recently retrieved and updated from online advertising service 1, online advertising service 2, and traffic tracking service 1 on the current day at 9:34 am. This retrieved and updated information may be reflected in various parts of the graphical user interface in FIG. 7A.

Pacing overview control 716, spend pacing control 718, and goal pacing control 720 may each display a different level of detail regarding the advertising spending and conversions for the advertising campaigns. When activated, pacing overview control 716 may provide line items 722. Thus, FIG. 7A reflects when pacing overview control 716 has been selected. Example line items displayed for spend pacing control 718 are shown in FIG. 7B, and example line items displayed for goal pacing control 720 are shown in FIG. 7C.

In FIG. 7B, the same or similar header information may be displayed on the graphical user interface. The interface also includes line items 724, which lists a number of advertising campaigns with information related to each campaign arranged in columns. One or more of these columns may be sortable. In general, line items 724 relate to the same advertising campaigns as line items 722, but with more detail regarding advertising spending.

For instance, like line items 722, line items 724 include columns for the monthly advertising spending goal (“monthly budget”) as well as the month-to-date advertising spending pace (“pace”) for each advertising campaign. Further, line items 724 include columns for month-to-date planned advertising spending, as well as month-to-date actual advertising spending.

Line items 724 also include columns related to the current day's advertising spending, under the aggregate column label “Today's Spending.” These columns include the current day's planned advertising spending (“Planned”), amounts spent using online advertising service 1 (“Adv. Serv. 1”) and online advertising service 2 (“Adv. Serv. 2”), total spent (“Total”), and daily spending pace (“Pace”). In particular, the spending pace may be calculated as the total spent divided by the planned advertising spending.

Among other advantages, these features of the graphical user interface allow the advertiser and/or advertising agency to rapidly determine the advertising spending status of a number of advertising campaigns. In particular, displaying the daily pace of advertising spending for each advertising campaign allows the advertiser and/or advertising agency to determine which advertising campaigns should be subject to more or less spending and how the spending should change.

Like FIG. 7B, FIG. 7C depicts the same or similar header information on the graphical user interface. The interface also includes line items 726, which lists a number of advertising campaigns with information related to each campaign arranged in columns. One or more of these columns may be sortable. In general, line items 726 relate to the same advertising campaigns as line items 722, but with more detail regarding conversion goals.

For instance, line items 726 include columns for the conversion goal type (leads or revenue in these examples) as well as the conversion goal (“goal”) for each advertising campaign. For leads-based goals, the targeted number of leads is provided in this column, while for revenue-based goals, the targeted amount of revenue is provided.

Line items 726 also include columns for targeted return on advertising spending (ROAS) or cost per lead (CPL), as well as month-to-date ROAS or CPL. In FIG. 7C, these columns are abbreviated as “Goal ROAS/CPL” and “Current ROAS/CPL,” respectively. Used for advertising campaigns with revenue-based conversion goals, ROAS represents the amount spent on advertising divided by the revenue from conversions attributable to that advertising. Used for advertising campaigns with leads-based conversion goals, CPL represents the amount of spend on advertising divided number of conversions attributable to that advertising. Thus, in FIG. 7C, “Goal ROAS/CPL” is the amount planned to be spent on advertising for the current month divided by the conversion goal associated with this spending. “Current ROAS/CPL” is the amount spent on advertising so far for current month divided by the conversion goal associated with this spending for the month to date.

Further, line items 726 include columns for month-to-date conversion goals under the aggregate column label “Monthly Goals.” These columns may include planned monthly conversion goals (“Planned”), month-to-date actual conversions (“Actual”), and month-to-date conversion pace (“Pace”). In particular, the monthly conversion pace may be calculated as the month-to-date actual conversions divided by the month-to-date planned conversions.

Line items 726 also include columns related to the current day's conversion goals, under the aggregate column label “Today's Goals.” These columns include the current day's planned conversion goals (“Planned”), the current day's actual conversions (“Actual”), and the current day's daily conversion pace (“Pace”). In particular, the daily conversion pace may be calculated as actual conversions for the current day divided by the planned conversions for the current day.

Among other advantages, these features of the graphical user interface allow the advertiser and/or advertising agency to rapidly determine the conversion status of a number of advertising campaigns. Notably, displaying the daily pace of conversions for each advertising campaign allows the advertiser and/or advertising agency to determine which advertising campaigns are performing above or below conversion goals for the current date. This may allow the advertiser and/or advertising agency to identify the impact that particular ads, keywords, or ad placements have on the advertising campaigns.

FIG. 7D depicts examples of “hot” advertising campaigns in terms of monthly advertising spending. The graphical user interface of FIG. 7D may be reached from that of other figures by selecting the “hot” indicator of monthly spend filtering control 708. As such, the number “3” in monthly spend filtering control 708 is highlighted, indicating that 3 “hot” advertising campaigns are shown. Line items 728 include the advertising campaigns from line items 724 in which the month-to-date advertising spending exceeds the month-to-date advertising spending goal by more than the example threshold extent of 5%.

Similarly, FIG. 7E depicts examples of “cold” advertising campaigns in terms of monthly advertising spending. The graphical user interface of FIG. 7E may be reached from that of other figures by selecting the “cold” indicator of monthly spend filtering control 708. As such, the number “5” in monthly spend filtering control 708 is highlighted, indicating that 5 “cold” advertising campaigns are shown. Line items 730 include the advertising campaigns from line items 724 in which the month-to-date advertising spending falls short of the month-to-date advertising spending goal by more than the example threshold extent of 5%.

FIG. 7F depicts examples of “okay” advertising campaigns in terms of monthly conversions. The graphical user interface of FIG. 7F may be reached from that of other figures by selecting the “okay” indicator of monthly goal filtering control 710. As such, the number “8” in monthly goal filtering control 710 is highlighted, indicating that 8 “okay” advertising campaigns are shown. Line items 732 include the advertising campaigns from line items 726 in which the month-to-date advertising conversion pace (represented in the column “Pace” under the “Monthly Goals” heading) meets or exceeds the month-to-date advertising conversion goal.

Similarly, FIG. 7G depicts examples of “cold” advertising campaigns in terms of monthly conversions. The graphical user interface of FIG. 7G may be reached from that of other figures by selecting the “cold” indicator of monthly goal filtering control 710. As such, the number “3” in monthly goal filtering control 710 is highlighted, indicating that 3 “cold” advertising campaigns are shown. Line items 734 include the advertising campaigns from line items 726 in which the month-to-date conversion pace falls short of the month-to-date conversion goal.

Advantageously, the graphical user interfaces depicted in FIGS. 7D-7G allow an advertiser and/or advertising agency to rapidly determine which advertising campaigns are reaching or exceeding their goals, and which are not. When a large number of advertising campaigns are being operated simultaneously, the filters in monthly spend filtering control 708 and monthly goal filtering control 710 allow the advertiser and/or advertising agency to focus on the campaigns that are likely to warrant the most attention.

### 5. Example Operations

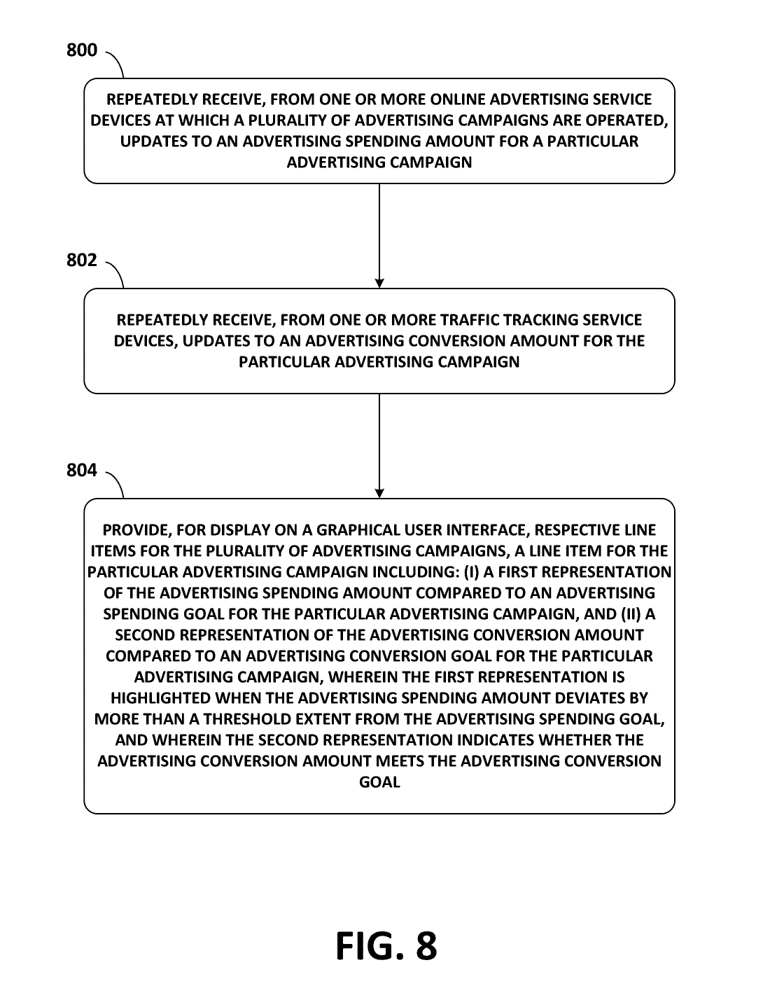

FIG. 8 is a flow chart illustrating a method according to an example embodiment. The process illustrated by FIG. 8 may be carried out by a computing device, such as computing device 200, and/or a cluster of computing devices, such as server cluster 304. However, the process can be carried out by other types of devices or device subsystems. For example, the process could be carried out by a portable computer, such as a laptop or a tablet device.

Block 800 may involve repeatedly receiving, from one or more online advertising service devices at which a plurality of advertising campaigns are operated, updates to an advertising spending amount for one or more particular advertising campaigns. The one or more online advertising service devices may be under the control of or operated by one or more online advertising services that integrate ads with the content of various publishers. The advertising spending amount may be an amount that has been spent on advertising for the one or more particular advertising campaigns.

Block 802 may involve repeatedly receiving, from one or more traffic tracking service devices, updates to an advertising conversion amount for the one or more particular advertising campaigns. The one or more online traffic tracking service devices may be under the control of or operated by one or more traffic tracking services that track usage of web sites, URLs, applications, phone numbers, and so on. The advertising conversion amount may take the form of ad impressions, click-throughs, leads, and/or revenue. In some cases, at least some updates to the advertising conversion amount may be received from the one or more online advertising service devices (e.g., when the advertising conversion amount is measured in terms of impressions or click-throughs).

Repeatedly receiving the advertising spending amount from the one or more online advertising service devices and the advertising conversion amount from the one or more traffic tracking service devices may occur at least once per hour. However, this reception may occur at other frequencies, such as every 1, 2, 5, 10, 15, 20, 30 or 60 minutes, once per every one or more hours, continuously, or randomly.

Block 804 may involve providing, for display on a graphical user interface, respective line items for the plurality of advertising campaigns. A line item for the one or more particular advertising campaigns may include (i) a first representation of the advertising spending amount compared to an advertising spending goal for the one or more particular advertising campaigns, and (ii) a second representation of the advertising conversion amount compared to an advertising conversion goal for the one or more particular advertising campaigns. The first representation may be highlighted when the advertising spending amount deviates by more than a threshold extent from the advertising spending goal. The second representation may indicate whether the advertising conversion amount meets the advertising conversion goal.

The threshold extent may be within the range of 1% to 10% for example. However, other threshold extents may be possible. For instance, the threshold extent may be in the form of a monetary amount rather than a percentage.

In some embodiments, the graphical user interface is communicatively coupled to a second computing device (e.g., a client computing device). Thus, providing the respective line items may involve transmitting representations of the respective line items from the computing device to the second computing device. On the other hand, the graphical user interface may be displayed upon the computing device.

The graphical user interface may also display respective advertising spending amounts compared to respective advertising spending goals for each of the plurality of advertising campaigns. The graphical user interface may additionally display respective advertising conversion amounts compared to respective advertising conversion goals for each of the plurality of advertising campaigns.

The respective line items may be displayed in rows on the graphical user interface. Further, the first representation and the second representation may be displayed in columnar format on the graphical user interface, and the line items may be sortable by column.

In some embodiments, the advertising spending amount is a to-date sum of advertising spending on the one or more particular advertising campaigns over a pre-defined period of one or more days. The advertising spending goal may include day-by-day spending sub-goals for the predefined period, and the first representation may compare the to-date sum of the advertising spending to a to-date sum of the day-by-day spending sub-goals.

Additionally, the graphical user interface may include a control that changes the display to include monthly advertising spending detail for the one or more particular advertising campaigns and current-day advertising spending detail for the one or more particular advertising campaigns (see, e.g., FIG. 7B). The monthly advertising spending detail may include at least two of: the advertising spending goal, a to-date sum of day-to-day advertising spending sub-goals over the pre-defined period of time, the to-date sum of advertising spending, or the first representation. The current-day advertising spending detail may include at least two of: a current-day advertising spending sub-goal, current-day advertising spending broken out across at least two online advertising services at which the plurality of advertising campaigns are operated, or a representation comparing the current-day advertising spending sub-goal to the current-day advertising spending.

In some embodiments, the advertising conversion amount is a to-date sum of the advertising conversions for the one or more particular advertising campaigns over a pre-defined period of one or more days. The advertising conversion goal may include day-by-day conversion sub-goals for the predefined period. The second representation may compare the advertising conversion amount to a to-date sum of the day-by-day conversion sub-goals.

Additionally, the graphical user interface may include a control that changes the display to include monthly advertising conversion detail for the one or more particular advertising campaigns and current-day advertising conversion detail for the one or more particular advertising campaigns (see, e.g., FIG. 7C). The monthly advertising conversion detail includes at least two of: the advertising conversion goal, the to-date sum of day-to-day advertising conversion sub-goals, the advertising conversion amount, or the second representation. The current-day advertising conversion detail includes at least two of: a current-day advertising conversion sub-goal, current-day advertising conversion amount, or a representation comparing the current-day advertising conversion sub-goal to the current-day advertising conversion amount. The second representation may also include an indication of whether the advertising conversions for the one or more particular advertising campaigns are lead-based conversions or revenue-based conversions.

In some embodiments, the graphical user interface includes a first control that filters the display to include only advertising campaigns for which the respective advertising spending amounts exceed the respective advertising spending goals by more than the threshold extent (see, e.g., FIG. 7D). The graphical user interface may include a second control that changes the display to include only advertising campaigns for which the respective advertising spending amounts fall short of the respective advertising spending goals by more than the threshold extent (see, e.g., FIG. 7E).

Moreover, the graphical user interface may include a third control that filters the display to include only advertising campaigns for which the respective advertising conversion amounts meet the respective advertising conversion goals (see, e.g., FIG. 7F). The graphical user interface may further include a fourth control that changes the display to include only advertising campaigns for which the respective advertising conversion amounts do not meet the respective advertising conversion goals (see, e.g., FIG. 7G).

In some embodiments, the graphical user interface includes one or more controls that filter the display by advertising campaigns with undefined advertising spending goals or by advertising campaigns with undefined advertising conversion goals. In this way, advertising campaigns with undefined goals may be readily identified so that these goals can be defined, should doing so be desirable.

The graphical user interface controls herein may be any form of button, selector, dial, switch, slider, menu item, data item, or other component that can be selected by a user.

The embodiments of FIG. 8 may be simplified by the removal of any one or more of the features shown therein. Further, these embodiments may be combined with features, aspects, and/or implementations of any of the previous figures or otherwise described herein.

### 6. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including substantially concurrent or in reverse order, depending on the functionality involved. Further, more or fewer blocks and/or functions can be used with any of the ladder diagrams, scenarios, and flow charts discussed herein, and these ladder diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A method comprising:
repeatedly receiving, by a computing device from one or more online advertising service devices at which a plurality of advertising campaigns are operated, updates to an advertising spending amount for one or more particular advertising campaigns, wherein the advertising spending amount is a to-date sum spent on the one or more particular advertising campaigns over a pre-defined period of one or more days;
repeatedly receiving, by the computing device from one or more traffic tracking service devices, updates to an advertising conversion amount for the one or more particular advertising campaigns, wherein the advertising conversion amount is a to-date sum of advertising conversions for the one or more particular advertising campaigns over the pre-defined period of one or more days, and wherein the one or more traffic tracking service devices are separate from the one or more online advertising service devices; and
providing, by the computing device for display on a graphical user interface to a client device, respective line items for the plurality of advertising campaigns, a line item for the one or more particular advertising campaigns including: (i) a first percentage representation of the advertising spending amount compared to an advertising spending goal for the one or more particular advertising campaigns, and (ii) a second percentage representation of the advertising conversion amount compared to an advertising conversion goal for the one or more particular advertising campaigns, wherein the first percentage representation is highlighted when the advertising spending amount deviates by more than a pre-defined threshold extent from the advertising spending goal, and wherein the second percentage representation indicates whether the advertising conversion amount meets or exceeds the advertising conversion goal, and wherein reception of the respective line items causes the client device to display, on the graphical user interface of the client device, the first percentage representation and the second percentage representation.

2. The method of claim 1, wherein the pre-defined threshold extent is within the range of 1% to 10%.

3. The method of claim 1, wherein the graphical user interface is communicatively coupled to the client device, and wherein providing the respective line items comprises transmitting representations of the respective line items from the computing device to the client device.

4. The method of claim 1, wherein the graphical user interface also displays respective advertising spending amounts compared to respective advertising spending goals for each of the plurality of advertising campaigns, and wherein the graphical user interface also displays respective advertising conversion amounts compared to respective advertising conversion goals for each of the plurality of advertising campaigns.

5. The method of claim 1, wherein the computing device also receives at least some updates to the advertising conversion amount from the one or more online advertising service devices.

6. The method of claim 1, where in the computing device repeatedly receives the advertising spending amount from the one or more online advertising service devices and the advertising conversion amount from the one or more traffic tracking service devices at least once per hour.

7. The method of claim 1, wherein the respective line items are displayed in rows on the graphical user interface, wherein the first percentage representation and the second percentage representation are displayed in columnar format on the graphical user interface, and wherein the line items are sortable by column.

8. The method of claim 1, wherein the advertising spending goal includes day-by-day spending sub-goals for the pre-defined period, and wherein the first percentage representation compares the to-date sum of the advertising spending to a to-date sum of the day-by-day spending sub-goals.

9. The method of claim 8, wherein the graphical user interface includes a control that changes the display to include monthly advertising spending detail for the one or more particular advertising campaigns and current-day advertising spending detail for the one or more particular advertising campaigns,
wherein the monthly advertising spending detail for the one or more particular advertising campaigns includes at least two of: the advertising spending goal, a to-date sum of day-to-day advertising spending sub-goals over the pre-defined period, the to-date sum of advertising spending, or the first percentage representation, and
wherein the current-day advertising spending detail for the one or more particular advertising campaigns includes at least two of: a current-day advertising spending sub-goal, current-day advertising spending broken out across at least two online advertising services at which the plurality of advertising campaigns are operated, or a representation comparing the current-day advertising spending sub-goal to the current-day advertising spending.

10. The method of claim 1, wherein the advertising conversion goal includes day-by-day conversion sub-goals for the predefined period, and wherein the second percentage representation compares the advertising conversion amount to a to-date sum of the day-by-day conversion sub-goals.

11. The method of claim 10, wherein the graphical user interface includes a control that changes the display to include monthly advertising conversion detail for the one or more particular advertising campaigns and current-day advertising conversion detail for the one or more particular advertising campaigns,
wherein the monthly advertising conversion detail for the one or more particular advertising campaigns includes at least two of: the advertising conversion goal, the to-date sum of day-to-day advertising conversion sub-goals, the advertising conversion amount, or the second percentage representation, and
wherein the current-day advertising conversion detail for the one or more particular advertising campaigns includes at least two of: a current-day advertising conversion sub-goal, current-day advertising conversion amount, or a representation comparing the current-day advertising conversion sub-goal to the current-day advertising conversion amount.

12. The method of claim 10, wherein the second percentage representation also includes an indication of whether the advertising conversions for the one or more particular advertising campaigns are lead-based conversions or revenue-based conversions.

13. The method of claim 1, wherein the graphical user interface includes a first control that filters the display to include only advertising campaigns for which the respective advertising spending amounts exceed the respective advertising spending goals by more than the pre-defined threshold extent, and wherein the graphical user interface includes a second control that changes the display to include only advertising campaigns for which the respective advertising spending amounts fall short of the respective advertising spending goals by more than the pre-defined threshold extent.

14. The method of claim 13, wherein the graphical user interface includes a third control that filters the display to include only advertising campaigns for which the respective advertising conversion amounts meet or exceed the respective advertising conversion goals, and wherein the graphical user interface includes a fourth control that changes the display to include only advertising campaigns for which the respective advertising conversion amounts do not meet the respective advertising conversion goals.

15. The method of claim 1, wherein the graphical user interface includes controls that filter the display by advertising campaigns with undefined advertising spending goals or by advertising campaigns with undefined advertising conversion goals.

16. An article of manufacture including a non-transitory computer-readable medium, having stored thereon program instructions that, upon execution by a computing device, cause the computing device to perform operations comprising:
repeatedly receiving, from one or more online advertising service devices at which a plurality of advertising campaigns are operated, updates to an advertising spending amount for one or more particular advertising campaigns, wherein the advertising spending amount is a to-date sum spent on the one or more particular advertising campaigns over a pre-defined period of one or more days;
repeatedly receiving, from one or more traffic tracking service devices, updates to an advertising conversion amount for the one or more particular advertising campaigns, wherein the advertising conversion amount is a to-date sum of advertising conversions for the one or more particular advertising campaigns over the pre-defined period of one or more days, and wherein the one or more traffic tracking service devices are separate from the one or more online advertising service devices; and
providing, for display on a graphical user interface to a client device, respective line items for the plurality of advertising campaigns, a line item for the one or more particular advertising campaigns including: (i) a first percentage representation of the advertising spending amount compared to an advertising spending goal for the one or more particular advertising campaigns, and (ii) a second percentage representation of the advertising conversion amount compared to an advertising conversion goal for the one or more particular advertising campaigns, wherein the first percentage representation is highlighted when the advertising spending amount deviates by more than a pre-defined threshold extent from the advertising spending goal, and wherein the second percentage representation indicates whether the advertising conversion amount meets or exceeds the advertising conversion goal, and wherein reception of the respective line items causes the client device to display, on the graphical user interface of the client device, the first percentage representation and the second percentage representation.

17. The article of manufacture of claim 16, wherein the graphical user interface also displays respective advertising spending amounts compared to respective advertising spending goals for each of the plurality of advertising campaigns, and wherein the graphical user interface also displays respective advertising conversion amounts compared to respective advertising conversion goals for each of the plurality of advertising campaigns.

18. The article of manufacture of claim 16, wherein the advertising spending goal includes day-by-day spending sub-goals for the pre-defined period, and wherein the first percentage representation compares the to-date sum of the advertising spending to a to-date sum of the day-by-day spending sub-goals.

19. The article of manufacture of claim 16, wherein the graphical user interface includes a first control that filters the display to include only advertising campaigns for which the respective advertising spending amounts exceed the respective advertising spending goals by more than the pre-defined threshold extent, and wherein the graphical user interface includes a second control that changes the display to include only advertising campaigns for which the respective advertising spending amounts fall short of the respective advertising spending goals by more than the pre-defined threshold extent.

20. A computing device comprising:
at least one processor;
memory; and
program instructions, stored in the memory, that upon execution by the at least one processor cause the computing device to perform operations comprising:
repeatedly receiving, from one or more online advertising service devices at which a plurality of advertising campaigns are operated, updates to an advertising spending amount for one or more particular advertising campaigns, wherein the advertising spending amount is a to-date sum spent on the one or more particular advertising campaigns over a pre-defined period of one or more days;
repeatedly receiving, from one or more traffic tracking service devices, updates to an advertising conversion amount for the one or more particular advertising campaigns, wherein the advertising conversion amount is a to-date sum of advertising conversions for the one or more particular advertising campaigns over the pre-defined period of one or more days, and wherein the one or more traffic tracking service devices are separate from the one or more online advertising service devices; and
providing, for display on a graphical user interface to a client device, respective line items for the plurality of advertising campaigns, a line item for the one or more particular advertising campaigns including: (i) a first percentage representation of the advertising spending amount compared to an advertising spending goal for the one or more particular advertising campaigns, and (ii) a second percentage representation of the advertising conversion amount compared to an advertising conversion goal for the one or more particular advertising campaigns, wherein the first percentage representation is highlighted when the advertising spending amount deviates by more than a pre-defined threshold extent from the advertising spending goal, and wherein the second percentage representation indicates whether the advertising conversion amount meets or exceeds the advertising conversion goal, and wherein reception of the respective line items causes the client device to display, on the graphical user interface of the client device, the first percentage representation and the second percentage representation.
